(19) United States
(12) Patent Application Publication
(10) Pub. No.: US 2017/0316445 A1
(43) Pub. Date: Nov. 2, 2017

(54) MULTIPLE-OBJECTIVE CONTROL OF CAMPAIGNS

(71) Applicant: AOL Advertising Inc., Dulles, VA (US)

(72) Inventor: Niklas Karlsson, Mountain View, CA (US)

(21) Appl. No.: 15/144,484

(22) Filed: May 2, 2016

(51) Int. Cl. G06Q 30/02

(52) U.S. Cl. CPC G06Q 30/0243; G06Q 30/0275; G06Q 30/0246; G06Q 30/0247

(57) ABSTRACT

Embodiments of the present invention provide systems, methods, and computer storage media directed at controlling a campaign. In embodiments, a method includes receiving event values respectively associated with corresponding events. The method can then utilize these event values in calculating an estimated impression value for a present logical interval of the campaign. The method can further include generating a price control signal based on a desired return on investment (ROI) associated with the campaign and an observed ROI of a previous logical interval of the campaign. Based on the estimated impression value and the price control signal, a bid price can be computed for the current logical interval of the campaign. This bid price can then be transmitted to a market associated with the campaign. Other embodiments may be described and/or claimed herein.

### TECHNICAL FIELD

The present disclosure relates generally to computing. More specifically, and without limitation, the present disclosure relates to systems and methods for controlling a marketing campaign based on multiple objectives.

### BACKGROUND

Online marketers are interested in placing marketing messages on websites to promote their products or services (also known as “impressions”). Influenced by a marketing message, a user may perform a “click” based on a marketing message or take another “action” such as completing an online form to request additional information with regard to the associated product or service. If the user later purchases the product or service, the purchase is referred to as a “conversion” of the impression. In general, online marketers pay based on, for example, impressions, clicks, views, or conversions over the course of a marketing campaign, hereinafter merely referred to as a “campaign,” in an effort to achieve a desired revenue for the campaign. In a campaign, revenue generally refers to the amount of money actually spent or the number of events delivered.

The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### BRIEF DESCRIPTION OF THE DRAWINGS

FIG. 1 depicts an illustrative marketing system, in accordance with embodiments of the present disclosure.

FIG. 2 depicts an illustrative online marketing control system for controlling an online marketing campaign operating in an online marketing network, in accordance with various embodiments of the present disclosure.

FIG. 3 depicts an illustrative campaign control system, in accordance with various embodiments of the present disclosure.

FIG. 4 depicts an illustrative process flow for controlling an online marketing campaign, in accordance with various embodiments of the present disclosure.

FIG. 5 is a block diagram of an example computing device in which various embodiments of the present disclosure may be employed.

### DETAILED DESCRIPTION OF THE EMBODIMENTS

As discussed in greater detail below, in various embodiments, a campaign control system can be configured to attempt to increase, or maximize, total value of a marketing campaign to which the campaign control system is assigned. To accomplish this, the campaign control system can be configured to achieve a desired pacing, or budget, within the constraints of a minimum desired return on investment (ROI) for the campaign. The ROI of a campaign can be represented as the ratio of the total value delivered by the campaign divided to the total cost of impressions for the campaign (i.e., total value/total cost). The total value of a campaign refers to the cumulative impression value of all awarded impressions. Impression value refers to the likelihood-adjusted aggregate dollar value of all relevant branding and performance events that could potentially result from each awarded impression. Relevant branding and performance events are referred to herein collectively as events and are discussed in greater detail below. The total cost of impressions for the campaign refers to the cumulative cost over all impressions awarded to the campaign. The cost of an impression refers to the actual cost of the impression in an associated market (e.g., clearing price in a second price cost model).

Reference will now be made in detail to illustrative embodiments of the invention, examples of which are illustrated in the accompanying drawings. Wherever possible, the same reference numbers will be used throughout the drawings to refer to the same or like parts.

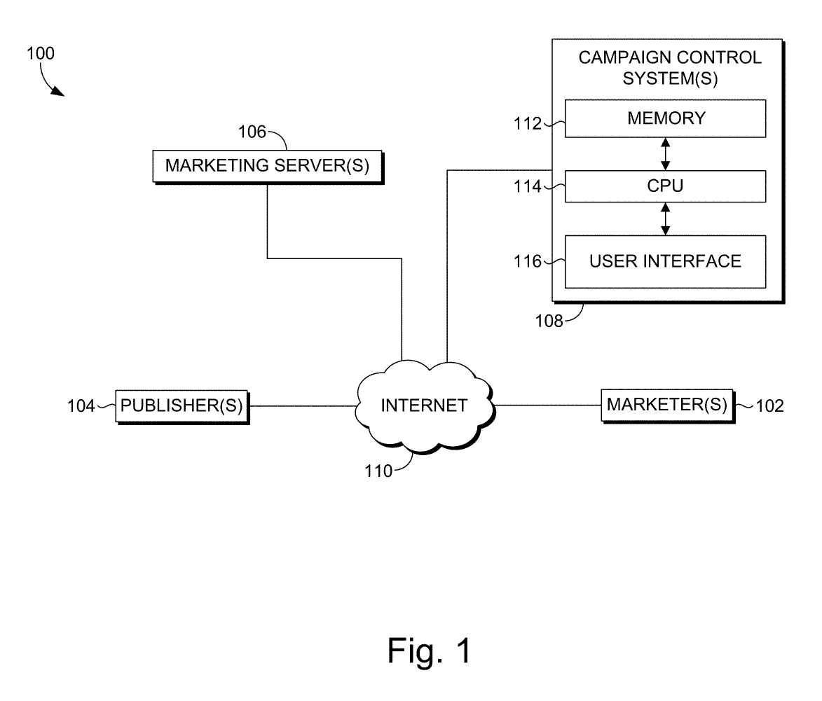

FIG. 1 depicts an illustrative marketing system 100, in accordance with embodiments of the present disclosure. As shown in FIG. 1, marketing system 100 may include one or more marketers 102, publishers 104, marketing servers 106, and campaign control systems 108 that are in communication with one another through a network, such as the Internet 110. The number and orientation of the computing components in FIG. 1 is provided for purposes of illustration only. Any other number and orientation of components is possible. For example, one or more marketers 102, publishers 104, marketing servers 106, and campaign control systems 108 may be combined or co-located and/or communicate directly with one another, instead of over Internet 110. The components of FIG. 1 may include any type or configuration of computers and/or servers, such as, for example, a server cluster, a server farm, load balancing servers, distributed servers, etc. In addition, each component may include one or more processors, memories or other data storage devices (i.e., computer-readable storage media), such as hard drives, NOR or NAND flash memory devices, or Read Only Memory (ROM) devices, etc., communications devices, and/or other types of computing elements.

Marketer 102 represent computing components associated with entities having online marketing content (e.g., banner ads, pop-ups, etc.) that the entities desire to deliver to online consumers. Marketer 102 may interact with publishers 104, marketing servers 106, and/or campaign control systems 108 through the Internet 110. Thus, marketer 102 may be able to communicate marketing information, such as ad information, targeting information, consumer information, budget information, bidding information, etc., to other entities in marketing system 100.

Publishers 104 represent computing components associated with entities having inventories of available online marketing space. For example, publishers 104 may include computing components associated with online content providers, search engines, e-mail programs, web-based applications, or any computing component or program having online user traffic. Publishers 104 may interact with marketers 102, marketing servers 106, and/or controllers 108 via the Internet 110. Thus, publishers 104 may be able to communicate inventory information, such as site information, demographic information, cost information, etc., to other computing components in system 100.

Marketing servers 106 may include servers or clusters of servers configured to process marketing information from marketer 102 and/or inventory information from publishers 104, either directly or indirectly. In certain embodiments, marketing servers 106 may be remote web servers that receive marketing information from marketer 102 and serve ads to be placed by publishers 104. Marketing servers 106 may be configured to serve ads across various domains of publishers 104, for example, based on marketing information provided by marketers 102. Marketing servers 106 may also be configured to serve ads based on contextual targeting of web sites, search results, and/or user profile information, all of which can be utilized in determining a target audience. In some embodiments, marketing servers 106 may be configured to serve ads based on control signals generated by campaign control systems 108.

Campaign control system 108 may include computing systems configured to receive information from computing components in system 100, process the information, and generate marketing control signals to be sent to other computing components in system 100, according to the illustrative methods described herein. As discussed in greater detail below, campaign control system 108 can be configured to attempt to increase, or maximize, total value of the campaign to which the campaign control system 300 is assigned. Campaign control systems 108 may include any type or combination of computing systems, such as clustered computing machines and/or servers, including virtual computing machines and/or virtual servers. Campaign control systems 108 may include, for example, implementations of Adlearn Open Platforms (AOP) control systems offered by America Online (AOL) of New York, N.Y. In some embodiments, campaign control systems 108 may include an assembly of hardware, including a memory 112, a central processing unit (“CPU”) 114, and/or a user interface 116. Memory 112 may include any type of RAM or ROM embodied in a physical, computer-readable storage medium, such as magnetic storage including floppy disk, hard disk, or magnetic tape; semiconductor storage such as solid state disk (SSD) or flash memory; optical disc storage; or magneto-optical disc storage. CPU 114 may include one or more processors for processing data according to instructions stored in the memory, for example to perform the methods and processes discussed in detail herein. The functions of the processor may be provided by a single dedicated processor or by a plurality of processors. Moreover, the processor may include, without limitation, digital signal processor (DSP) hardware, or any other hardware capable of executing software. User interface 116 may include any type or combination of input/output devices, such as a display monitor, graphical user interface, touch-screen or pad, keyboard, and/or mouse. In other embodiments, campaign control systems 108 may include virtual representations of hardware operating, for example, on a virtualization server.

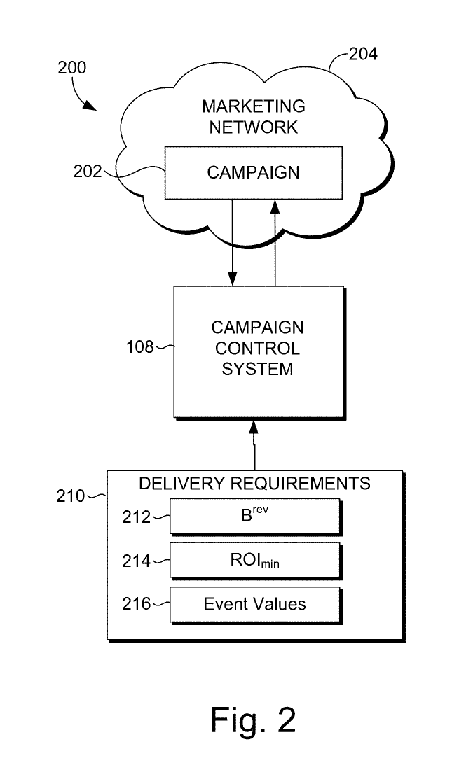

FIG. 2 depicts an illustrative online marketing environment 200 for controlling an online marketing campaign 202 operating in an online marketing network 204. Marketing network 204 may include a network or collection of one or more marketers 102, one or more publishers 104, marketing servers 106, campaign control systems 108, or other components of system 100. Elements of marketing network 204 may operate to receive impression requests associated with one or more marketing inventories, e.g., from publishers 104 such as websites or other computing components with an inventory of online marketing space. Marketing network 204 may also group impression requests for various marketing campaigns, e.g., according to impressions to be “targeted” based on a combination of attributes defined by the marketing requests. Marketing network 204 may also accept bids (e.g., from one or more campaign control systems 108) on the impression requests and process the bids to serve ads to the impression requests.

Any number or type of marketing campaigns 202 may be operated within marketing network 204, across various marketing servers and domains associated with the Internet. Online marketing environment 200 may be implemented by one or more of the marketers 102, publishers 104, marketing servers 106, and/or campaign control systems 108 described in FIG. 1. For example, online marketing environment 200 may represent the interaction of one or more campaign control systems 108 with other computing components in system 100.

In one embodiment, online marketing environment 200 may include one or more instances of campaign control system 108. Campaign control system 108 may comprise computers or servers connected to the Internet. Such computers or servers may be configured as described with respect to campaign control system 108, as depicted by FIG. 1, or in any other suitable configuration. Alternatively, campaign control system 108 may be implemented by software modules executed by CPUs 114 of campaign control system 108. Campaign control system 108 may be embodied entirely in hardware, entirely in software, or in any combination of hardware and software implemented across any number of computing devices.

Campaign control system 108 may be provided with a set of delivery requirements 210, which may be adjustable design parameters set by a user. For instance, the set of delivery requirements may include, a desired pacing 212, B^{rev} (e.g., daily budget goals, daily impression delivery goals), a desired minimum return on investment 214, ROIₘᵢₙ, event values 216 associated with event objectives within the campaign, targeting requirements (e.g., based on a demographic analysis) for a target audience, and/or spread requirements (e.g. to control marketing across inventory units/cells/segments, and/or user targets, etc.). The set of delivery requirements 210 may be implemented by campaign control system 108 as discussed in greater detail below.

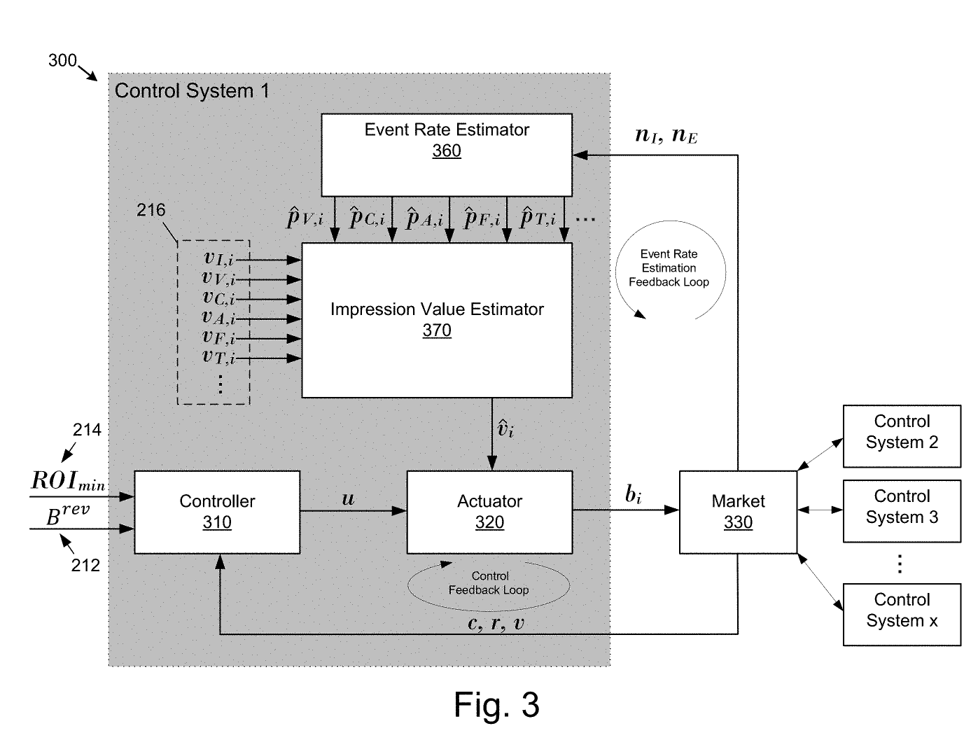

FIG. 3 depicts a block diagram of a portion of an illustrative campaign control system 300 for controlling online marketing campaigns, in accordance with various embodiments of the present disclosure. Campaign control system 300 may generally be configured to utilize data observed in previous logical intervals of market 330 to satisfy a set of delivery requirements (e.g., delivery requirements 210 of FIG. 2). As used herein, a previous logical interval refers to a previous time interval of a marketing campaign. In operation, a campaign may be logically or arbitrarily divided into various logical intervals. Logical intervals may be uniformly divided time intervals, such as based on second, minute, hour, day, week, month, or so on. In addition, logical intervals may be logically tied with certain units or milestones in a campaign. Such units may relate to orders of a product or service (e.g., conversions) after launching the campaign, e.g., every thousand orders. Such units may also, or alternatively, include a unit of budget spend on the campaign, e.g., every thousand dollars. In these cases, where the logical intervals are logically tied with certain units or milestone in a campaign, the logical intervals may be considered heterogeneous time intervals.

In embodiments, campaign control system 300 can be configured to attempt to increase, or maximize, total value of the campaign to which the campaign control system 300 is assigned. To accomplish this, campaign control system 300 can be configured, as discussed in greater detail below, to achieve a desired pacing, or budget, within the constraints of a minimum desired return on investment (ROI) for the campaign. The ROI of a campaign can be represented as the quotient of the total value delivered by the campaign divided by the total cost of impressions for the campaign (i.e., total value/total cost). The total value of a campaign refers to the cumulative value of all relevant branding and performance events that result from the awarded impressions. Relevant branding and performance events are referred to herein collectively as events and are discussed in greater detail below. The total cost of impressions for the campaign refers to the cumulative cost over all impressions awarded to the campaign. The cost of an impression refers to the actual cost of the impression in an associated market (e.g., clearing price in a second price cost model).

As depicted, campaign control system 300 includes a controller 310 (e.g., campaign control system 108 of FIGS. 1 & 2), a actuator 320, a market 330, an event rate estimator 360, and an impression value estimator 370. Each of these components may be communicatively coupled with one another, for example, as depicted in FIG. 3. This communicative coupling may be, for example, via a bus, network, shared memory, etc., or any combination thereof. It will be appreciated that additional components may be included within campaign control system 300 that are not depicted. These additional components could include components that are integrated between two of the depicted components. For example, in various embodiments, a cost estimator could be included between market 330 and controller 310. In addition, the functionality of the depicted components could be combined into fewer components or further divided into more components. As such, the depicted configuration of campaign control system 300 is merely meant to be illustrative and should not be treated as limiting of the present disclosure.

Campaign controller 310 is configured to take as input a desired pacing reference signal 212, B^{rev}. Desired pacing 212 may be user defined and may also be referred to as desired revenue for a defined period of time within the marketing campaign. As used herein, revenue in this context refers to actual dollars spent or actual events delivered. As such, desired pacing may be expressed as monetary units (e.g., dollars) or as a number of events. For example, if a marketing campaign has a daily budget of $900 and has spent $800 in a given day, observed pacing for the campaign on that given day is $800.

Campaign controller 310 is also configured to take as input a desired minimum ROI 214, ROIₘᵢₙ. The desired minimum ROI 214 may be user defined and can be represented as a number that depicts, for example, the minimum desired value that the user would like to achieve for an expended cost for the marketing campaign. As such, desired ROI 214 may be expressed, for example, as a percentage, ratio, decimal number, etc. For example, values below 1 could indicate the user is anticipating expending more cost than the value imparted by the delivered impression; values above 1 could indicate the user is anticipating that the value imparted by the delivered impressions exceeds the cost expended, and a value of 1 could indicate the user is anticipating that the value imparted by the delivered impressions is equal to the cost expended during the campaign. It will be appreciated that the value imparted to the user is subjective in nature and that different users may be looking to achieve different objectives, and, as such, may assign different values to different events.

Campaign controller 310 is also configured to take as input an observed cost, c, observed pacing, r, and an observed value, v, from a previous logical interval. These observed variables can be transmitted to controller 310 from market 330 via the depicted control feedback loop. Observed cost, c, can be determined from actual cost data for transactions that are observed in market 330. The observed cost may be, for example, a moving average calculated over a period of time. This period of time can be any duration of time that may be based upon certain campaign characteristics. For example, a shorter period of time can enable quicker reflection of changes in market 330; however the results could be noisier than those of a moving average calculated over a longer period of time. A moving average calculated over a longer period of time, on the other hand, can be less noisy than a moving average calculated over a shorter period of time, but is slow to react to market changes. As a result, the time period for such a moving average may be dependent on the campaign and/or volatility of market 330. A moving average may be calculated by a moving average filter (not depicted). In some embodiments, such a moving average filter may be in-line between market 330 and controller 310. Discrete observed costs in market 330 may be monitored, for example, via a cost sensor configured to obtain real-time data from marketplace 310. In embodiments, this real time data may be specific to the campaign to which campaign control system 300 is assigned.

Observed pacing, r, can be determined from actual pacing observed in market 330. As with observed cost, observed pacing may be a moving average calculated over a period of time. This period of time can be any duration of time that may be selected based upon certain campaign characteristics, such as those discussed above in reference to observed cost (e.g., speed of reflecting changes vs noise). Discrete observed pacing in market 330 may be monitored, for example, via a pacing sensor configured to obtain real-time data about the campaign to which campaign control system 300 is assigned.

Observed value, ν, can be determined from value observed for transactions that occurred in market 330. Such observed value can be based on the event values assigned to the campaign (e.g., event values 216). As with observed cost and observed pacing, observed value may be a moving average calculated over a period of time. This period of time can be any duration of time that may be selected based upon certain campaign characteristics, such as those discussed above in reference to observed cost (e.g., speed of reflecting changes vs noise). Discrete observed values in market 330 may be monitored, for example, via a value sensor configured to obtain real-time data about the campaign to which campaign control system 300 is assigned.

Controller 310 may be configured to determine an ROI error, e_{ROI}, and a pacing error, eₚ, based on the above discussed inputs to controller 310. From these errors, campaign controller 310 can automatically determine a price control signal, u. As used herein, automatic refers to the performance of an action without user input. In embodiments, the price control signal, u, is a result of a function of the ROI error and the pacing error, ƒ(e_{ROI}, eₚ). This function may be configured to attempt to facilitate obtaining the desired pacing within the limits of the minimum ROI and/or inventory available in market 330. As such, u, can be updated in such a way that (1) observed pacing approximately converges to desired pacing 212 while observed ROI remains at or above minimum ROI 214, (2) observed ROI approximately converges to minimum ROI 214 while observed pacing remains at or below desired pacing 212, or (3) observed pacing approximately converges to maximum possible delivery (the inventory for market 330 is exhausted) while the observed ROI remains at or above minimum ROI 214. In some embodiments, controller 310 can also be configured to generate an allocation control signal. Such an allocation control signal represents the percentage or ratio (e.g., point value from 0 to 1) of inventory the ad campaign is willing to purchase at the bid price discussed below.

In various embodiments, controller 310 may be configured to periodically update the price control signal, u, as well as an allocation control signal, if utilized. These periodic updates may take place at predefined time intervals (e.g., every 15 minutes), based on a specific occurrence (e.g., based on a magnitude of change to an error signal), or any other suitable period, or logical interval. In other embodiments, controller 310 may update the price control signal, u, in real time as the above discussed error signals, or reference signals, change. For example, it will be appreciated that the desired minimum ROI may change during the campaign based on any number of factors (e.g., if a desired minimum ROI cannot be achieved by the campaign while delivering the budget in full the desired minimum ROI may be decreased). In response to such a change, the controller 310 may automatically update the price control signal, u, in accordance with the updated ROIₘᵢₙ.

To facilitate obtaining the desired pacing 212 within the constraints of desired minimum ROI 214 to the marketer, the above described function, ƒ(e_{ROI}, eₚ), may utilize an adaptive control scheme in calculating the price control signal, u. Such an adaptive control scheme could calculate the u, and an optional allocation signal, based on a most recent value of the ROI error, a most recent value of the pacing error, and a stored controller state variable, which includes information about past control performance. Such an adaptive control scheme is known in the art and a person of ordinary skill in the art would be able to implement such a control scheme. In other embodiments, alternative control schemes may be utilized in place of the adaptive control scheme. Such control schemes are known in the art and would include an optimal control scheme, a model predictive control scheme, a proportional-integral-derivative (PID) control scheme, a robust control scheme, a stochastic control scheme, or any other suitable control scheme.

Event rate estimator 360 is configured to take as input an observed impression volume, n_{I}, and observed volumes for events, n_{E}. The volumes for events can include, but are not limited to, the number of impressions delivered that were in-view (e.g., within a displayed portion of a website); number impressions that resulted in a click; number of impressions that resulted in a conversion; number of video impressions that resulted in completion of an associated video ad; the number of impressions that were delivered within a target demographic; any other event, or any combination thereof. Each of these events can be considered an objective to a user (e.g., marketer) for which the user can assign a subjective dollar value, or weight. It will be appreciated that this list of events is not exhaustive and is merely meant to illustrate possible events for which volumes may be monitored within market 330. These volumes for events are collectively depicted as observed event volumes, n_{E}.

It will be appreciated that, in some embodiments, there can be a plurality of event rate estimators in campaign control system 300. In such embodiments each event rate estimator can be assigned to a specific segment within the campaign. As used herein a segment refers to a defined portion of market 330. Such a segment may be, for example, a website, a group of individuals identified by demographic analysis (e.g., males between the age of 25 and 35 in California), a distinct individual, etc. A segment may also be referred to in the art, and herein, as a cell or unit.

The observed impression volume, n_{I}, and the observed event volumes, n_{E} can be determined from actual observations in market 330. Discrete observed impression volumes for any discrete observed event volumes may be monitored in market 330, for example, via segment impression sensors (not depicted) and segment event sensors (not depicted), respectively. Such sensors can be configured to obtain real-time data about the segment to which these sensors are assigned.

Event rate estimator 360 can be configured to utilize the observed impression volume and the observed volumes for events to determine an estimated probability of the occurrence of each of the events for impression ‘i.’ As depicted, these estimated event probabilities include the estimated probability of an awarded impression being an in-view impression, \hat{p}_{V,i}; the estimated probability of an awarded impression resulting in a click, \hat{p}_{C,i}; the estimated probability of an awarded impression resulting in a conversion, \hat{p}_{A,i}; the estimated probability of an awarded impression resulting in fulfillment of a video ad (e.g., the video is completed or a certain percentage of the video ad is viewed), \hat{p}_{F,i}; and the estimated probability of an awarded impression being delivered to a target audience (e.g., demographic), \hat{p}_{T,i}. It will be appreciated that the depicted estimated event probabilities are merely meant to be illustrative of possible events and that more or fewer events could be included within these estimated probabilities without departing from the scope of this disclosure. It will also be appreciated that combinations of events could also be reflected within these event probabilities. For example, event rate estimator 360 could be configured to determine an estimated probability of an awarded impression being delivered to a target audience and resulting in a click. These estimated probabilities produced by event rate estimator 360 can then be output to impression value estimator 370.

Impression value estimator 370 is configured to take as input the estimated event probabilities output by event rate estimator 360 and corresponding event values 216. The depicted corresponding event values include values that have been associated with each of the events for which a probability has been produced. As such, the event values 216 include a value associated with an in-view impression, ν_{V,i}; a value associated with a click, ν_{C,i}; a value associated with a conversion, ν_{A,i}; a value associated with fulfillment of a video ad (e.g., the video is completed or a certain percentage of the video ad is viewed), ν_{F,i}; a value associated with an impression delivered to a target audience (e.g., demographic), ν_{T,i}. In addition, the depicted event values 216 include a value associated with each awarded impression, ν_{I,i}. Because it can be assumed that the probability of an awarded impression resulting in an awarded impression is 100%, or 1, then the event rate estimator 360 need not be configured to produce an estimated probability for an awarded impression. These event values could be input to campaign control system 300 by a user (e.g., marketer) and could be subjectively determined (e.g., determined by business objectives of the marketer with respect to the campaign). It will be appreciated that the depicted event values are merely meant to be illustrative of possible events and that more or fewer events could be included within these event values without departing from the scope of this disclosure. It will also be appreciated that, as with the above discussed estimated probabilities, combinations of events could also be reflected within these event values. For example, a value could be associated with an awarded impression being delivered to a target audience and resulting in a click.

From the estimated probabilities received from event rate estimator 360 and the event values defined within event values 216, the impression value estimator 370 can calculate a likelihood-adjusted value for each awarded impression. To accomplish this, impression value estimator 370 can be configured to determine the product of each event probability and the corresponding event value and to sum these values together to determine an estimated impression value, \hat{v}ᵢ. As such, in the depicted embodiment, impression value estimator 370 can be configured to determine the estimated impression value in accordance with the following equation:

\hat{ν}ᵢ=ν_{I,i}+\hat{p}_{V,i}ν_{V,i}+\hat{p}_{C,i}ν_{C,i}+\hat{p}_{A,i}ν_{A,i}+\hat{p}_{F,i}ν_{F,i}+\hat{p}_{T,i}ν_{T,i} Equation 1

From equation 1, it will be appreciated that by assigning a value of zero to any event value effectively removes this value from the calculation of the estimated impression value without impacting the rest of equation 1. It will be appreciated that Equation 1 is merely meant to be illustrative in nature, and that additional, or fewer, event values can be included without departing from the scope of this disclosure.

It will also be appreciated that the estimated impression value calculation depicted by equation 1 supports impression dependent event values, where ‘i’ represents the index of different groups of impressions. This enables distinguishing between groups of impression inventory such as, for example, distinguishing between premium and non-premium inventory. As used in this context, premium inventory may refer to impression inventory within the market that is considered to be of higher quality, or value, than non-premium inventory that is considered to be of lesser quality. This premium versus non-premium designation could be based on any applicable factor, such as, for example, specific websites (e.g., websites containing content associated with the product or service being marketed could be considered premium over generic websites), demographics associated with the inventory, etc. As a more specific example, the branding value of an impression may differ in that v_{I,i} is set to a larger value if i corresponds to a teenage user, and v_{I,i} is set to a lower value otherwise.

Actuator 320 takes the price control signal, u; the estimated impression value, \hat{ν}ᵢ; and an allocation control signal, if used, as input. Actuator 320 may utilize the combination of these inputs to calculate a bid price, bᵢ, for the respective segment. In some embodiments, the bid price, bᵢ, is calculated by taking the product of u and \hat{ν}ᵢ. In other embodiments, the bid price may be a capped segment bid price calculated, for example, using the equation bᵢ=min(maxCPI, uₚ\hat{ν}ᵢ), where maxCPI is max cost per impression, or, as another example, equation bᵢ=min(maxCPIᵢ, uₚ\hat{ν}ᵢ), where maxCPIᵢ is max cost per impression for segment i. It will be appreciated by someone of ordinary skill in the art that these examples are merely meant to illustrative and are not intended to limit the scope of this disclosure. For example, min can be replaced by max and/or the min (max) operation may be conditional based on user, ad, or impression specific information. In addition, the capping may apply only for a certain type of user, a certain time of the day, in a certain geographic region, etc.

Because the bid price, bᵢ, is calculated based on the estimated impression value, \hat{ν}ᵢ, produced by impression value estimator 370, the bid price can be depicted based on the estimated impression value. As such, utilizing the event values to target different events can be represented in terms of how these event values impact the estimated impression value and therefore impact the bid price. Examples of this are discussed below.

As a first example, if the campaign merely wants to concentrate on impressions delivered, then the following values can be set to zero, \hat{ν}_{V,i}=ν_{C,i}=ν_{A,i}=ν_{F,i}=ν_{T,i}=0. In such an example, where all impressions are valued equally, ν_{I,i} is not impression dependent (i.e., is impression independent) and is therefore the same for all impressions and can be expressed as ν_{I}. As such, the bid, bᵢ, could be represented by the following equation: bᵢ=uν_{I}.

In another example, if the campaign merely wants to concentrate on clicks delivered, then the following values can be set to zero, ν_{I,i}=ν_{V,i}=ν_{A,i}=ν_{F,i}=ν_{T,i}=0. In such an example, where all clicks are valued equally, ν_{C,i} is not impression dependent and is therefore the same for all impressions and can be expressed as ν_{c}. As such, the bid, bᵢ, could be represented by the following equation: bᵢ=u\hat{p}_{C,i}ν_{C}.

In yet another example, if the campaign merely wants to concentrate on in-view impression (i.e., impressions that are displayed on screen), then the following values can be set to zero, ν_{I,i}=ν_{C,i}=ν_{A,i}=ν_{F,i}=ν_{T,i}=0. In such an example, where all in-view impressions are valued equally, ν_{V,i} is not impression dependent and is therefore the same for all impressions and can be expressed as ν_{V}. As such, the bid, bᵢ, could be represented by the following equation: bᵢ=u\hat{p}_{V,i}ν_{V}.

In yet another example, if the campaign wants to concentrate on number of impressions and conversion performance, then the following values can be set to zero, ν_{V,i}=ν_{C,i}=ν_{F,i}=ν_{T,i}=0. In such an example, where all impressions are valued equally and all conversions are valued equally. That is, ν_{I,i} and ν_{A,i} are not impression dependent and are therefore the same for all impressions and can be expressed as ν_{I} and ν_{A}, respectively. As such, the bid, bᵢ, could be represented by the following equation: bᵢ=u(ν_{I}+\hat{p}_{A,i}ν_{A}).

In a final example, if the campaign wants to concentrate on premium in-view impressions and in-target impressions, then the following values can be set to zero, ν_{I,i}=ν_{C,i}=ν_{A,i}=ν_{F,i}=0. Because the campaign is concentrating on premium in-view impression, all impressions are not equal with respect to the in-view value and therefore ν_{V,i} is impression dependent, where ‘i’ indicates an index distinguishing between premium and non-premium impressions. With respect to in-target impressions however, all in-target impressions are valued equally and therefore, ν_{T,i} is not impression dependent and is therefore the same for all impressions and can be expressed as ν_{T}. As such, the bid, bᵢ, could be represented by the following equation: bᵢ=u(\hat{p}_{V,i}ν_{V,i}+\hat{p}_{T,i}ν_{T}). It will be appreciated that the above discussed examples are merely meant to be illustrative and that any number of additional configurations can be adapted from the above described embodiments.

Market 330 represents a bidding environment in which marketers place ad requests for marketing space that is offered by publishers. The above discussed components facilitate a marketer in obtaining the desired pacing, B^{rev}, within the limits of desired ROI, ROIₘᵢₙ, and/or inventory available in marketing market 330.

As depicted, additional control systems (e.g., control systems 2 through control system x) can also be communicating with market 330. Each of these control systems can be configured in a similar manner to control system 300; however, it will be appreciated that the event values, desired minimum ROI, and the desired pacing may vary between each of these addition control systems.

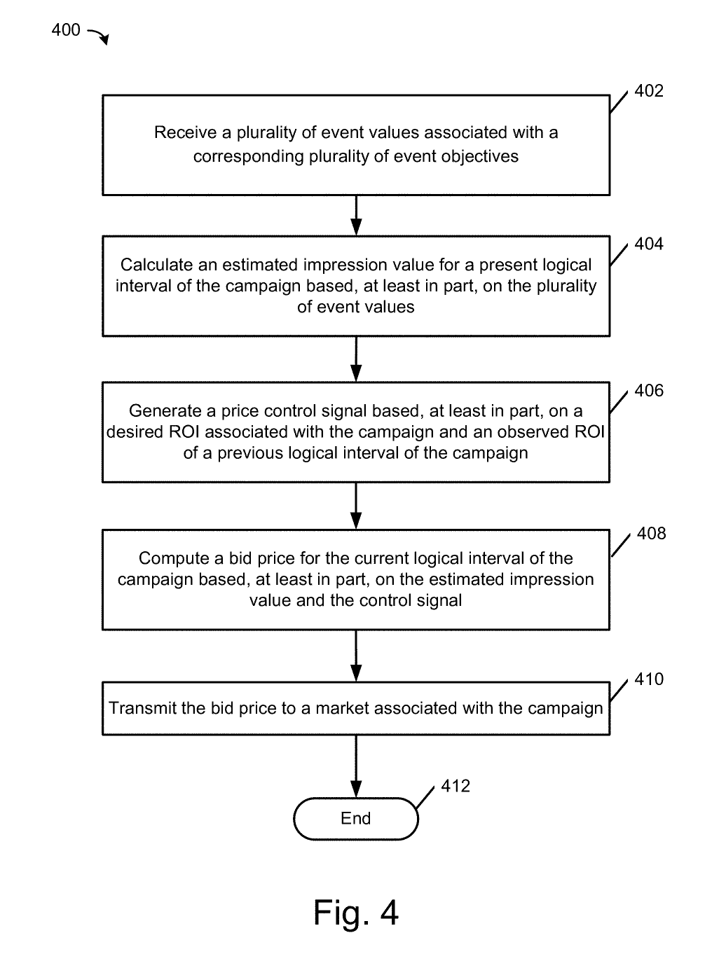

FIG. 4 depicts an illustrative process flow 400 for controlling online marketing campaigns by a campaign control system (e.g., campaign control system 300 of FIG. 3), in accordance with various embodiments of the present disclosure. Process flow 400 may begin at block 402 where a plurality of event values associated with a corresponding plurality of event objectives of a marketing campaign is received. In addition to the plurality of event values, as discussed below, a desired ROI indicator and a desired pacing indicator may also be received at block 402.

The corresponding plurality of event values can include values associated with each event that a campaign control system is configured to monitor for within a market associated with the campaign control system. As such, the event values can include a value associated with an in-view impression, ν_{V,i}; a value associated with a click, ν_{C,i}; a value associated with a conversion, ν_{A,i}; a value associated with fulfillment of a video ad (e.g., the video is completed or a certain percentage of the video ad is viewed), ν_{F,i}; a value associated with an impression delivered to a target audience (e.g., demographic), ν_{T,i}. In addition, such event values can also include a value associated with each awarded impression, ν_{I,i}. These event values could be input to the campaign control system by a user (e.g., marketer) and could be subjectively determined (e.g., determined by business objectives of the marketer with respect to the campaign). It will be appreciated that the above discussed event values are merely meant to be illustrative of possible events and that more or fewer events could be included within these event values without departing from the scope of this disclosure. It will also be appreciated that combinations of events could also be reflected within these event values. For example, a value could be associated with an awarded impression being delivered to a target audience and resulting in a click. Any event or combination of events capable of being monitored within a market associated with a campaign control system can be considered an objective and is contemplated as being within the scope of this disclosure.

At block 404 an estimated impression value for a present logical interval of the campaign is calculated based, at least in part, on the plurality of event values received at block 402. In various embodiments, this estimated impression value may be further based on probabilities of the occurrence of each event for which an event value has been defined. The calculation of such an estimated impression value can be accomplished in a same or similar manner to that described in reference to FIG. 3, above.

At block 406, a price control signal is generated by the campaign control system based, at least in part, on a desired ROI associated with the campaign and an actual ROI observed in a previous logical interval of the campaign. The desired ROI may be defined by a user and may be received as input to the campaign control system. In some embodiments, the desired ROI can represent a minimum desired ROI (e.g., ROI., 214) which a user (e.g., marketer) would like to achieve. The actual ROI observed in the previous logical interval can be based on a ratio of observed value of impressions delivered within the market during the previous logical interval to an observed cost of those impressions. It will be appreciated that observed value of the impressions would be calculated in accordance with the events delivered by those impressions in conjunction with the plurality of event values received at block 402. Observed value and observed cost can be generated in a same or similar manner to that discussed above in reference to FIG. 3.

In some embodiments, the price control signal determined at block 406 is also based on a desired pacing (e.g., B^{rev} 214 of FIG. 3) for the campaign and actual pacing observed in a previous logical interval of the campaign. As with the desired ROI, desired pacing may be defined by a user and may be received as input to the campaign control system. The actual pacing observed in the previous logical interval can be based on actual observations of pacing within the associated market and can be generated in a same or similar manner to that discussed above in reference to FIG. 3.

As discussed in reference to FIG. 3, the price control signal may be determined based on an ROI error, calculated from the desired ROI and the observed ROI, and a pacing error, calculated from the desired pacing and the observed pacing. In some embodiments, the price control signal is a result of a function of both the ROI error and the pacing error, (e.g., ƒ(e_{ROI}, eₚ) discussed above in reference to FIG. 3). This function may be configured to attempt to facilitate obtaining the desired pacing within the limits of the minimum ROI and/or inventory available in the market. As such, u, can be updated in such a way that (1) observed pacing approximately converges to desired pacing while observed ROI remains at or above the desired ROI, (2) observed ROI approximately converges to the desired ROI while observed pacing remains at or below desired pacing, or (3) observed pacing approximately converges to maximum possible delivery (the inventory in the market is exhausted) while the observed ROI remains at or above the desired ROI.

In some embodiments, the price control is determined utilizing an adaptive control scheme to calculate the price control. Such an adaptive control scheme could calculate the control signal, and an optional allocation signal, based on a most recent value of the ROI error, a most recent value of the pacing error, and a stored controller state variable, which includes information about the past control performance. The adaptive control scheme is known in the art and a person of ordinary skill in the art would be able to implement such a control scheme. In other embodiments, alternative control schemes, may be utilized in place of the above discussed adaptive control scheme. Such control schemes are known in the art and would include an optimal control scheme, a model predictive control scheme, a proportional-integral-derivative (PID) control scheme, a robust control scheme, a stochastic control scheme, or any other suitable control scheme.

At block 408 a bid is calculated based on the price control signal determined at block 406 and the estimated impression value calculated at block 404. In some embodiments, the bid price is calculated by taking the product of the price control signal and the estimated impression value. In other embodiments, the bid price may be a capped bid price calculated, for example, using the equation bᵢ=min(maxCPI, uₚ\hat{ν}ᵢ), where maxCPI is max cost per impression. It will be appreciated by someone of ordinary skill in the art that this example is merely meant to be illustrative and is not intended to limit the scope of this disclosure. For example, min can be replaced by max and/or the min (max) operation may be conditional based on user, ad, or impression specific information. In addition, the capping may apply only for a certain type of user, a certain time of the day, in a certain geographic region, etc. Finally at block 410, the bid is transmitted to the market associated with the campaign.

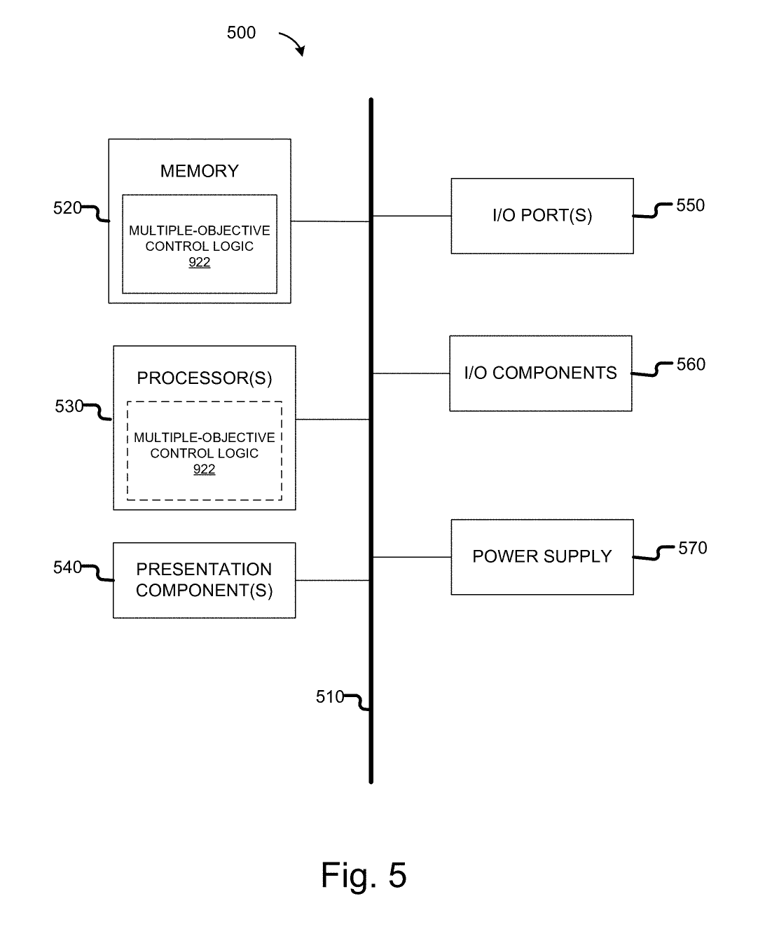

Having described embodiments of the present invention, an example operating environment in which embodiments of the present invention may be implemented is described below in order to provide a general context for various aspects of the present invention. Referring to FIG. 5, an illustrative operating environment, or computing platform, for implementing embodiments of the present invention is shown and designated generally as computing device 500. Computing device 500 is but one example of a suitable computing environment and is not intended to suggest any limitation as to the scope of use or functionality of the invention. Neither should the computing device 500 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The invention may be practiced in a variety of system configurations, including hand-held devices, consumer electronics, general-purpose computers, more specialized computing devices, etc. The invention may also be practiced in distributed computing environments where tasks are performed by remote-processing devices that are linked through a communications network.

With reference to FIG. 5, computing device 500 includes a bus 510 that directly or indirectly couples the following devices: memory 520, one or more processors 530, one or more presentation components 540, input/output (I/O) ports 550, I/O components 560, and an illustrative power supply 570. Bus 510 represents what may be one or more busses (such as an address bus, data bus, or combination thereof). Although depicted in FIG. 5, for the sake of clarity, as delineated boxes that depict groups of devices without overlap between these groups of devices, in reality this delineation is not so clear cut and a device may well fall within multiple ones of these depicted boxes. For example, one may consider a display to be one of the one or more presentation components 540 while also being one of the I/O components 560. As another example, processors have memory integrated therewith in the form of cache; however, there is no overlap between the one or more processors 530 and the memory 520. A person having ordinary skill in the art will readily recognize that such is the nature of the art, and it is reiterated that the diagram of FIG. 5 merely depicts an illustrative computing device that can be used in connection with one or more embodiments of the present invention. It should also be noticed that distinction is not made between such categories as “workstation,” “server,” “laptop,” “hand-held device,” etc., as all such devices are contemplated to be within the scope of computing device 500 of FIG. 5 and any other reference to “computing device,” unless the context clearly indicates otherwise.

Computing device 500 typically includes a variety of computer-readable media. Computer-readable media can be any available media that can be accessed by computing device 500 and includes both volatile and nonvolatile media, and removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 500. Computer storage media does not comprise signals per se. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 520 includes computer-storage media in the form of volatile and/or nonvolatile memory. The memory may be removable, non-removable, or a combination thereof. Typical hardware devices may include, for example, solid-state memory, hard drives, optical-disc drives, etc. Computing device 500 includes one or more processors 530 that read data from various entities such as memory 520 or I/O components 560. Presentation component(s) 540 present data indications to a user or other device. Illustrative presentation components include a display device, speaker, printing component, vibrating component, etc.

In various embodiments, memory 520 includes, in particular, temporal and persistent copies of multiple objective control logic 522. Multiple objective control logic 522 includes instructions that, when executed by one or more processors 530, result in computing device 500 performing the procedures of process 400, or any subset thereof. In various embodiments, multiple objective control logic 522 includes instructions that, when executed by processor 530, result in computing device 500 performing various functions associated with, but not limited to, campaign control system 300, or any components thereof.

In some embodiments, one or more processors 530 may be packaged together with multiple objective control logic 522. In some embodiments, one or more processors 530 may be packaged together with multiple objective control logic 522 to form a System in Package (SiP). In some embodiments, one or more processors 530 can be integrated on the same die with multiple objective control logic 522. In some embodiments, processor 530 can be integrated on the same die with multiple objective control logic 522 to form a System on Chip (SoC).

In the preceding detailed description, reference is made to the accompanying drawings which form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the preceding detailed description is not to be taken in a limiting sense, and the scope of embodiments is defined by the appended claims and their equivalents.

Various aspects of the illustrative embodiments have been described using terms commonly employed by those skilled in the art to convey the substance of their work to others skilled in the art. However, it will be apparent to those skilled in the art that alternate embodiments may be practiced with only some of the described aspects. For purposes of explanation, specific numbers, materials, and configurations are set forth in order to provide a thorough understanding of the illustrative embodiments. However, it will be apparent to one skilled in the art that alternate embodiments may be practiced without the specific details. In other instances, well-known features have been omitted or simplified in order not to obscure the illustrative embodiments.

Various operations have been described as multiple discrete operations, in turn, in a manner that is most helpful in understanding the illustrative embodiments; however, the order of description should not be construed as to imply that these operations are necessarily order dependent. In particular, these operations need not be performed in the order of presentation. Further, descriptions of operations as separate operations should not be construed as requiring that the operations be necessarily performed independently and/or by separate entities. Descriptions of entities and/or modules as separate modules should likewise not be construed as requiring that the modules be separate and/or perform separate operations. In various embodiments, illustrated and/or described operations, entities, data, and/or modules may be merged, broken into further sub-parts, and/or omitted.

The phrase “in one embodiment” or “in an embodiment” is used repeatedly. The phrase generally does not refer to the same embodiment; however, it may. The terms “comprising,” “having,” and “including” are synonymous, unless the context dictates otherwise. The phrase “A/B” means “A or B.” The phrase “A and/or B” means “(A), (B), or (A and B).”The phrase “at least one of A, B and C” means “(A), (B), (C), (A and B), (A and C), (B and C) or (A, B and C).”

What is claimed is:

1. A method of controlling campaign objectives comprising:
receiving, by a campaign control system, a plurality of event values associated with a corresponding plurality of events, the event values defining the campaign objectives;
calculating, by the campaign control system, an estimated impression value for a present logical interval of the campaign based, at least in part, on the plurality of event values;
generating, by the campaign control system, a price control signal based, at least in part, on a desired return on investment (ROI) associated with the campaign and an observed ROI of a previous logical interval of the campaign;
computing, by the campaign control system, a bid price for the current logical interval of the campaign based, at least in part, on the estimated impression value and the control signal; and
transmitting, by the campaign control system, the bid price to a market associated with the campaign.

2. The method of claim 1, further comprising:
receiving, by the campaign control system, the plurality of event values associated with the campaign objectives, wherein the plurality of event values are defined by a user of the computing system.

3. The method of claim 1, wherein calculating the estimated impression value for the present logical interval of the campaign is also based on a respective estimated probability of an impression within the market resulting in each of the plurality of events.

4. The method of claim 3, wherein the respective estimated probability is determined based on observed events of the previous logical interval of the campaign.

5. The method of claim 1, wherein generating the price control signal is further based on a desired pacing associated with the campaign and an observed pacing of the previous logical interval of the campaign.

6. The method of claim 5, further comprising:
determining an ROI error based on the desired ROI and an observed ROI of a previous logical interval of the campaign; and
determining a pacing error based on the desired pacing and an observed pacing of a previous logical interval of the campaign, wherein generating the price control signal is based on the ROI error and the pacing error.

7. The method of claim 1, wherein the campaign objectives are associated with one or more of:
in-view impressions;
impressions resulting in clicks;
impressions resulting in conversions;
impressions delivered to a target demographic of the campaign; or
completion of video content associated with the campaign.

8. The method of claim 1, wherein the plurality of event values include impression dependent event values.

9. The method of claim 7, wherein the plurality of event values include impression independent event values.

10. One or more computer-readable media having instructions stored thereon, wherein the instructions, when executed by one or more processors of a computing system, provide the computing system with a control system to:
receive a plurality of event values associated with a corresponding plurality of events, an indicator of a desired return on investment (ROI), and an indicator of a desired pacing, wherein the event values define objectives of a campaign to which the control system is assigned;
calculate an estimated impression value for a present logical interval of the campaign based, at least in part, on the plurality of event values;
determine an ROI error based on the desired ROI and an observed ROI of a previous logical interval of the campaign;
determine a pacing error based on the desired pacing and an observed pacing of a previous logical interval of the campaign;
generate a price control signal based, at least in part, on the ROI error and the pacing error;
compute a bid price for the current logical interval of the campaign based, at least in part, on the estimated impression value and the control signal; and
transmit the bid price to a market associated with the campaign.

11. The one or more computer-readable media of claim 10, wherein the control system is further to:
receive the plurality of event values, wherein the plurality of event values are defined by a user of the computing system.

12. The one or more computer-readable media of claim 10, wherein calculating the estimated impression value for the present logical interval of the campaign is also based on a respective estimated probability of an impression within the market resulting in each of the plurality of events.

13. The one or more computer-readable media of claim 12, wherein the respective estimated probability is determined based on observed events of the previous logical interval of the campaign.

14. The one or more computer-readable media of claim 10, wherein the objectives of the campaign are associated with one or more of:
in-view impressions;
impressions resulting in clicks;
impressions resulting in conversions;
impressions delivered to a target demographic of the campaign; or
completion of video content associated with the campaign.

15. A computing system comprising:
one or more processors; and
one or more computer-readable media having instructions stored thereon, wherein the instructions, when executed by the one or more processors cause the computing system to:
receive a plurality of event values associated with a corresponding plurality of events, an indicator of a desired return on investment (ROI), and an indicator of a desired pacing, wherein the event values define objectives of a campaign to which the computing system is assigned;
calculate an estimated impression value for a present logical interval of the campaign based, at least in part, on the plurality of event values;
determine an ROI error based on the desired ROI and an observed ROI of a previous logical interval of the campaign;
determine a pacing error based on the desired pacing and an observed pacing of a previous logical interval of the campaign;
generate a price control signal based, at least in part, on the ROI error and the pacing error;
compute a bid price for the current logical interval of the campaign based, at least in part, on the estimated impression value and the control signal; and
transmit the bid price to a market associated with the campaign.

16. The computing system of claim 15, wherein the computing system is further to:
receive the plurality of event values associated with the campaign objectives, wherein the plurality of event values are defined by a user of the computing system.

17. The computing system of claim 15, wherein calculating the estimated impression value for the present logical interval of the campaign is also based on a respective estimated probability of an impression within the market resulting in each of the plurality of events.

18. The computing system of claim 17, wherein the respective estimated probability is determined based on observed events of the previous logical interval of the campaign.

19. The computing system of claim 15, wherein the campaign objectives are associated with one or more of:
in-view impressions;
impressions resulting in clicks;
impressions resulting in conversions;
impressions delivered to a target demographic of the campaign; or
completion of video content associated with the campaign.

20. The computing system of claim 15, wherein the plurality of event values include impression dependent event values and impression independent event values.
